(19) United States
(12) Patent Application Publication
(10) Pub. No.: US 2025/0132989 A1
(43) Pub. Date: Apr. 24, 2025

(54) MANAGEMENT OF HIERARCHICAL PRODUCT PARAMETERS IN THE HIERARCHY OF OPERATIONAL FACTORS

(71) Applicant: DevRev, Inc., Palo Alto, CA (US)

(72) Inventors: Dominik Damjakob, Austin, TX (US); Shlomi Vaknin, San Jose, CA (US); Ashwini Vasanth, West Lafayette, IN (US)

(73) Assignee: DevRev, Inc., Palo Alto, CA (US)

(21) Appl. No.: 18/919,285

(22) Filed: Oct. 17, 2024

Related U.S. Application Data
(60) Provisional application No. 63/544,730, filed on Oct. 18, 2023.

(51) Int. Cl. H04L 41/5009; H04L 41/0893; H04L 67/02

(52) U.S. Cl. CPC H04L 41/5009; H04L 41/0893; H04L 67/02

(57) ABSTRACT

Techniques for classifying hierarchical product parameters in a hierarchy of operational factors for an offering operating in a unified platform are disclosed. Hierarchical product parameters including lower-tier parameters are obtained. An identifier associated with each lower-tier parameter is retrieved, providing information about its structure and location. An address associated with the identifier is determined. The lower-tier parameter is classified under an appropriate parameter based on the address. A hierarchical link is established between the classified lower-tier parameter and the appropriate parameter. A hierarchical product parameter map is updated based on the classification. The technique improves classification accuracy by extracting host information from API paths and classifying lower-tier parameters under appropriate higher-tier parameters. This provides an efficient approach for automatically classifying and updating the hierarchy while maintaining data integrity and relationships, offering significant benefits in management, development, and communication of the offering.

### CROSS-REFERENCE TO RELATED APPLICATIONS

The present application claims the benefit of priority to U.S. Provisional Application 63/544,730, filed on Oct. 18, 2023, which is hereby incorporated by reference in its entirety

### TECHNICAL FIELD

The subject matter described herein, in general, relates to managing a hierarchy of operational factors, and in particular to, classifying hierarchical product parameters in the hierarchy of operational factors for an offering operating in a unified platform.

### BACKGROUND

An offering, such as a product and/or a service, offered by an organization typically encompasses several operational facets to satisfactorily meet diverse user demands. The several operational facets are often facilitated by various resources that operate in distinct environments. Since the several facets are unified in terms of the offering they are deployed to serve, the resources frequently exchange information for efficient and coherent functioning of the several facets. For instance, given a software product, the distinct environments may be a development environment and a user environment. The development environment typically includes tools, frameworks, and systems used by software engineers to design, code, test, and debug the product. On the other hand, the user environment encompasses the platforms, devices, and systems where end-users interact with and utilize the product.

### BRIEF DESCRIPTION OF DRAWINGS

A detailed description is provided with reference to the accompanying figures. In the figures, the left-most digit(s) of a reference number identifies the figure in which the reference number first appears. The same numbers are used throughout the drawings to reference features and components.

FIG. 1A illustrates a system to implement some embodiments of the invention.

FIG. 1B illustrates a block diagram of a connected environment, in accordance with an example implementation of the present subject matter.

FIG. 2 illustrates a block diagram of a comprehensive framework comprising hierarchical product parameters for an offering, in accordance with an example implementation of the present subject matter.

FIG. 3 illustrates a Part Discovery module for implementing an embodiment of the present invention.

FIG. 4 illustrates a block diagram of a host extraction module for implementing an embodiment of the present invention.

FIG. 5A illustrates schematics of a system for classifying hierarchical product parameters, in accordance with an example of the present subject matter.

FIG. 5B illustrates a block diagram of a computing system suitable for implementing an embodiment of the present subject matter.

FIG. 6 illustrates a block diagram of a method for facilitating classification of hierarchical product parameters, in accordance with an example implementation of the present subject matter.

FIG. 7 illustrates a non-transitory computer-readable medium for facilitating classification of hierarchical product parameters, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

In modern connected computing environments, organizations frequently develop and deploy a wide range of products, services, and solutions across multiple discrete ecosystems. The products, services, and solutions may be collectively referred to as an offering and may encompass any deliverable that an organization may provide to its users or customers. For effective functioning, the offering may interface with a multitude of disparate locations, devices, and entities within the discrete ecosystems. The discrete ecosystems may be inhabited by, not limited thereto, both user-end entities and developer-end entities associated with the offering. The discrete ecosystems, while distinct, may not be entirely isolated as they operate towards a common organizational goal. Therefore, discrete ecosystems may at least be interconnected through shared resources, data, and dependencies, creating a complex web of interactions. Consequently, careful management and orchestration of the interactions between the resources becomes crucial for the successful operation of the offering within the interconnected computing environment.

The discrete ecosystems encompass a diverse set of resources, including hardware infrastructure, software platforms, data storage systems, network components, and the like. The resources may be intricately configured to collectively support the functionality and performance of the offering. As the operations progress in the discrete ecosystems, the diverse set of resources may generate continuous data streams pertaining to various activities or changes occurring within each ecosystem. While the data streams are typically unique to their originating ecosystem, they often reference entities and resources that span across multiple ecosystems.

The data streams may be used by the entities in the connected environment for generating and managing actionable items, for example, incidents, tickets, and issues. The actionable items are commonly associated with various sources and parameters related to the offering. The different sources and parameters may often correspond to specific segments of a comprehensive framework that encompasses the offering and multifaceted aspects of the offering.

The comprehensive framework is composed of hierarchical product parameters for the offering and the different segments of the comprehensive framework relate to one or more hierarchical product parameters. The hierarchical product parameter is referred to as a part of the offering, such as a part of a product or a part of a service. The hierarchical product parameters represent a structured taxonomy of, for example, capabilities, features, microservices, sub-modules related to an offering. Further, a hierarchy comprising the hierarchical product parameters often includes multiple levels of granularity, ranging from high-level categories including higher-tier hierarchical product parameters down to lower-level categories including lower-tier hierarchical product parameters. The generation of new hierarchical product parameters in the hierarchy of operational factors for the offering can affect the classification of the lower-tier hierarchical product parameters under appropriate higher-tier hierarchical product parameters. The hierarchy of operational factors is referred to as a part hierarchy centered around the offering, such as a product hierarchy and a service hierarchy. For example, features “app.devrev.ai/auth” and “docs.devrev.ai/auth”, originating from different capabilities or products but having similar properties, are likely to be grouped into the same feature. Without verifying the source (host) of such API paths will result in an unsorted grouping of lower-tier hierarchical product parameters (features) under inappropriate higher-tier hierarchical product parameters (capability, product, or service).

The hierarchical product parameters for the offering are generally classified and categorized within the organization by using either a manual approach or by using rule-based approaches. However, the manual approach is inherently susceptible to inconsistencies and temporal misalignments with the actual state of a deployed offering. The discrepancy between the manually classified and maintained hierarchical product parameters and a current state of deployments, for example, real-time configuration updates for the resources, may lead to a cascade of operational inefficiencies. For instance, actionable items generated within an enterprise management system may reference outdated resources, potentially misdirecting the reference calls or causing delays in issue resolution. Moreover, if any modifications are made referencing outdated versions of the resources, the inconsistencies may propagate amongst other hierarchical product parameters and resources, affecting a wide range of functions.

The challenge is further aggravated by the rapid pace of modern software development and deployment practices, such as continuous integration and delivery (CI/CD) pipelines. The CI/CD pipelines enable frequent updates and feature releases, which can quickly render manually maintained product hierarchies obsolete. The discrepancies between manually maintained hierarchical product parameters and the actual state of deployments can have far-reaching consequences beyond operational inefficiencies. Such discrepancies may impact strategic decision-making as organizations may base their plans on outdated or inaccurate representations of the offering's capabilities. Additionally, the inconsistencies may affect user experience and satisfaction, as support teams may provide incorrect information or troubleshooting steps based on incorrectly classified hierarchical product parameters.

Further, the conventional rule-based classification approaches are also susceptible to inconsistencies and are not accurate or efficient. The rule-based approaches follow rigid rules for the classification of the hierarchical product parameter. However, such classification approaches are difficult to maintain and extend, requiring developers to constantly rewrite rules and actions to accommodate new customer demands or evolving features of the offering. In addition, the conventional approaches may result in an unsorted grouping of lower-tier hierarchical product parameters under inappropriate higher-tier hierarchical product parameters.

One or more implementations of the present specification provide a classification method of product and service hierarchies. Embodiments of the invention may act upon any number or type of event hierarchies. To achieve the objective above, one or more implementations of the present specification provide the following technical solutions:

The present subject matter envisages techniques for managing hierarchical product parameters in a hierarchy of operational factors for an offering. According to one exemplary embodiment, the present subject matter provides systems and methods for classifying hierarchical product parameters in the hierarchy of operational factors for the offering operating in a unified platform. The offering may be a product, a service, or a combination of both. In an example, the classification technique may follow a bottom-up approach, where the lower-tier hierarchical product parameters (such as features and sub-features) may be used to infer and construct the higher-tier hierarchical product parameters (such as capabilities and products). The bottom-up approach may allow for a dynamic and data-driven classification system that can adapt to the evolving nature of complex offerings.

Further, the offering may have components operating in distinct ecosystems in a connected computing environment. The distinct ecosystems may be connected through the unified platform where an organization may integrate and manage various aspects of an offering's operations, resources, and processes. The unified platform may be implemented as a Software-as-a-Service (Saas) platform. The unified platform acts as a central hub unifying the distinct ecosystems within which various components of the offering operate, thereby enabling a holistic approach to generate, classify and maintain accurate hierarchical product parameters. For instance, the unified platform may integrate data from a development ecosystem (e.g., code repositories, build systems), an operations ecosystem (e.g., deployment logs, performance monitoring), and a customer-facing ecosystem (e.g., support tickets, usage analytics).

The hierarchical product parameter may be understood as a parameter associated with a specific level of granularity in the hierarchy of operational factors associated with the offering. The operational factors associated with the offering may span over the plurality of distinct ecosystems operating in relation to the product deployed in the connected environment. For instance, the operational factors may be divided amongst user-end entities and/or developer-end entities responsible for generating them or fixing them. The hierarchical product parameters may include lower-tier hierarchical product parameters, such as features and sub-features, and higher-tier hierarchical product parameters, such as offerings and capability.

The hierarchy of operational factors associated with the offering, such as the product or service includes the product or service as the origin entity. The product or service may have one or more capabilities, which are the core unit a user-end entity interacts with and to which revenue can be assigned. Capabilities may have an associated API namespace if delivered as a software product or service. Each capability may comprise an independent set of features, where features define product offerings that can be measurable, observable, upgradable, and potentially monetizable. In an example, the capabilities and/or features may link to backend constructs, termed sub-modules. The sub-modules may be referred to as a unit of deployment and may be an operational factor which composes a feature or capability.

The term “operational factor” thus refers to a component or piece of the hierarchy of operational factors associated with the product and/or service deployed in the connected environment. Exemplary operational factors include a particular capability, feature, microservice, sub-module, and the like. The term “hierarchical product parameter” refers to an operational factor in the hierarchy of operational factors for a particular ecosystem of the connected environment. In an example, for each specific ecosystem, there may be a hierarchy of the operational factors associated with the product and/or service and one or more hierarchical product parameters in relation to the operational factors. The hierarchical product parameter is referred to as a part of the product or service and the hierarchy of operational factors is referred to as a part hierarchy centered around the product or service. The terms offering, product, and service have been used interchangeably throughout the specification.

In an example implementation, hierarchical product parameters associated with an offering within a hierarchy of operational factors may be obtained. The hierarchical product parameters may include a lower-tier hierarchical product parameter of the offering. The lower-tier hierarchical product parameter refers to a specific element or attribute within a product's hierarchical structure that exists at a lower level of the hierarchy of operational factors. In an example, the lower-tier hierarchical product parameter may be a feature and a sub-feature. In an example, product parameter seeds may be used for obtaining or generating the hierarchical product parameters. The product parameter seed is a structured data object that encapsulates comprehensive information about the offering, including its capabilities, features, and sub-features. The product parameter seed may be a JavaScript Object Notation (JSON), Extensible Markup Language (XML), or Ain′t Markup Language (YAML) file.

In an example, the hierarchical product parameter may include plurality of capabilities and features associated with the offering. For instance, for a cloud-based software, the offering may be a customer relationship management system. Within the customer relationship management system, a capability may be “contact management”, a feature may be “contact import”, and a sub-feature may be “file import”. Each of the hierarchical product parameter may be associated with an identifier indicating the position of the hierarchical product parameter in the overall hierarchy of operational factors. For instance, the identifier may be unique tags, codes, or labels assigned to each lower-tier hierarchical product parameter to distinguish it from others and to indicate its position within the overall hierarchy of operational factors.

In an example implementation, the identifier may be retrieved and analyzed from the obtained hierarchical product parameters. In an example, the identifier may be an Application Programming Interface (API) path. The identifier may provide information about a hierarchical structure and a location of the lower-tier hierarchical product parameter. For instance, in the above example, the identifier for the “file import” sub-feature may include information that links the sub-feature to the “contact import” feature and the “contact management” capability. In an example, there may be a set of identifiers associated with the hierarchical product parameter.

In an example implementation, an address associated with the retrieved identifier may be determined. The address refers to a unique location or reference point within the hierarchical structure of hierarchical product parameters. The address may be a logical designation that helps in organizing and categorizing different hierarchical product parameters in the hierarchy of operational factors. For example, the address may be a host information. In an example, the address may be a domain of the URL. Based on the determined address, the lower-tier hierarchical product parameter may be classified under an appropriate hierarchical product parameter. The appropriate hierarchical product parameter may either be a higher-tier hierarchical product parameter or another lower-tier hierarchical product parameter. The higher-tier hierarchical product parameter refers to a specific element or attribute within a product's hierarchical structure that exists at a higher level of the hierarchy of operational factors. Higher-tier parameters include the offering itself or a capability within the hierarchy of operational factors. In an example, the “file import” sub-feature may be classified under the “contact import” feature. In another example, the “file import” sub-feature may be classified under “contact management” capability. In yet another example, the “contact import” feature may be classified under “contact management” capability.

In an example implementation, the information derived from the identifiers and addresses of the lower-tier hierarchical product parameters may be used to infer and construct higher-tier hierarchical product parameters. For instance, patterns and commonalities among the lower-tier hierarchical product parameters may be identified to group them logically into capabilities or products. In an example, multiple features with similar API path structures or shared domains may be grouped under a common capability.

In an example, user-provided information may be used to override or supplement the process. In cases where users have specific knowledge about the structure of the offering, they can provide input to guide the classification process. The user-provided information may sometimes lead to a top-down approach in specific areas of the hierarchy.

In an example implementation, a hierarchical link may be created between the classified lower-tier hierarchical product parameter and the appropriate hierarchical product parameter. The hierarchical link represents a logical relationship between the two parameters. The hierarchical links are vital for understanding the structure of the offering. The hierarchical links allow for easy navigation through the various levels of the offering, for example, from high-level capabilities down to specific features and sub-features. This structure can be particularly useful in complex systems where there may be hundreds or thousands of individual features and sub-features.

After the classification, a hierarchical product parameter map may be updated to reflect the changes in the hierarchical product parameters. The hierarchical product parameter map serves as a structured representation of all the hierarchical product parameters and their relationships within the hierarchy of operational factors for the offering. In an example, the hierarchical product parameters map may be updated upon detecting any change or relevant information on an existing hierarchical product parameter. The hierarchical product parameters map is referred to as a part table.

The present subject matter thus provides a flexible and efficient approach for automatically classifying hierarchical product parameters based on the set of identifiers and updating the hierarchy of operational factors while maintaining data integrity and relationships. The present subject matter improves the accuracy of the classification by extracting the host information from API paths and classifying lower-tier hierarchical product parameters under appropriate higher-tier hierarchical product parameters. Further, the present subject matter offers significant benefits in terms of management, development, and communication of the offering by automatically classifying and linking the hierarchical product parameters.

By accurately classifying and organizing the features and sub-features, the present subject matter provides valuable insights into product usage, customer needs, and potential areas for improvement or new feature development for the offering. The accurate classification of features and sub-features enable support teams to identify and resolve customer issues more quickly by linking them to specific hierarchical product parameters of the product or service. The automated nature of the classification process makes it easier to scale across multiple products and services, and to maintain the hierarchy with the evolution of the offerings over time. Further, the classification method integrates seamlessly with the existing unified platform, allowing for better coordination between development, operations, and customer-facing teams. These technical advantages collectively contribute to a more efficient, reliable, and accurate system for classifying the hierarchy of operational factors for the offering, addressing key challenges faced in conventional systems.

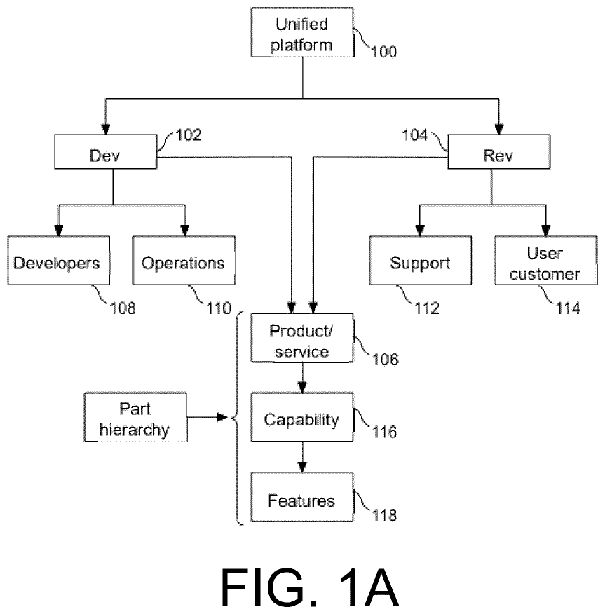

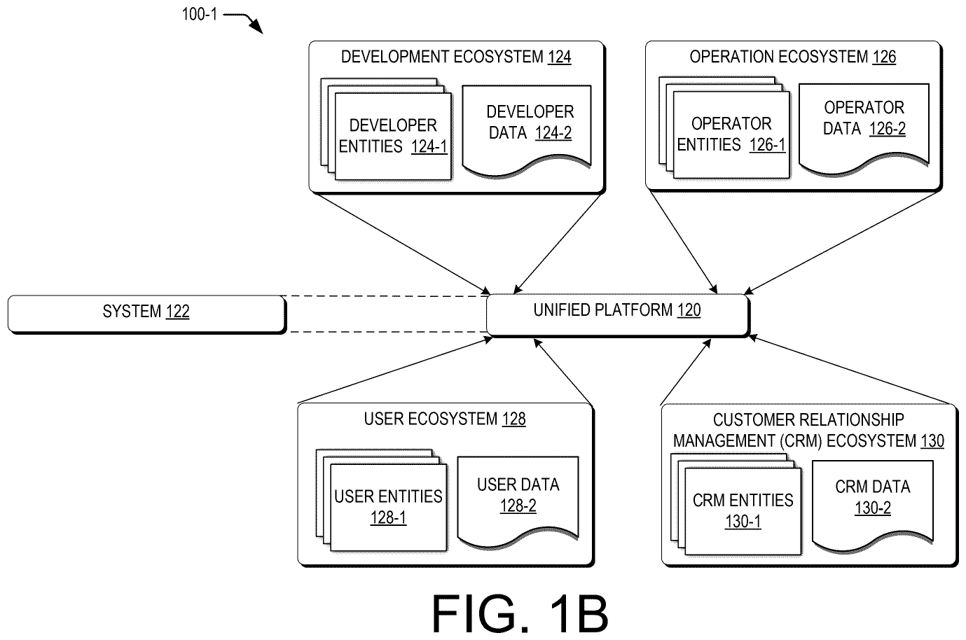

The present subject matter is further described with reference to FIGS. 1-7. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1A illustrates a system to implement some embodiments of the invention. FIG. 1B illustrates a block diagram of a connected environment, in accordance with an example implementation of the present subject matter. For the sake of brevity, FIG. 1A has been explained in conjunction with FIG. 1B.

FIG. 1A shows a unified platform 100 to implement an automated template for automatically clustering events into event hierarchies and autonomous classification and communication between these hierarchies. Event hierarchies are classified as Development-related hierarchies 102 and Revenue-related (customer-related) hierarchies 104. Developer-related hierarchies 102 are classified into two sub-event hierarchies: development hierarchy 108 and operation hierarchy 110. The development hierarchy 108 pertains to systems used by and interfaced with software developer activities used to “build” the software product. The Operations hierarchy 110 pertains to developer-related personnel that operate the systems/software for a computing product. Revenue-related hierarchies 104 are classified into two sub-event hierarchies: support hierarchy 112 and user/customer hierarchy 114. The support hierarchy 112 pertains to systems used by user and customer-facing support personnel, and the user/customer hierarchy 114 pertains to ordinary customers and users using the actual products. The events generated by the different hierarchies comprise a ‘Part’ 106 hierarchy centered around the ‘Product’ or ‘Service,’ the primary entity from which all Parts are related and branched. There are ‘Dev Parts’ and ‘Rev Parts’. A Product or service is defined as a set of Capabilities 116, the lowest level in the Part hierarchy where revenue can be assigned, a market category is created or attributed, and it is the core unit with which the consumer interacts. A ‘Capability’ 116 is defined with an independent set of Features that is prominent enough to define a minimum product offering that can be measurable, observable, upgradable, and potentially monetizable. Capabilities 116 may have an API namespace if delivered as a software product or service and can have associated service level agreements (SLA). Capabilities 116 can have configurable items classified as a Feature 118, wherein the Feature 118 is specific to a Capability 116 and can be enabled, metered, or tracked for usage. Further, Feature 118 provides entities and associated actions and/or toggles that can be executed (e.g., create, update, enable, disable) on the provided entities. Features 118 comprises a set of API paths, wherein an API path can be a runnable or linkable interface with which the customer interacts. Features can be further classified as Sub-Feature. In the present hierarchy, each Capability, each Feature, and each Sub-Feature is a ‘Part’ component.

The system 100 relies on the API path to discover a Feature (lower-tier Part). However, the present system for discovering lower-tier Parts may be prone to repetition in the context of different higher-tier Parts, or they may be considered identical and grouped. (Example: Features app.devrev.ai/auth vs. docs.devrev.ai/auth originating from different capabilities or products but having similar properties are likely to be grouped into the same Feature). Without verifying the source (host) of such API paths will result in an unsorted grouping of lower-tier Parts (Features) under inappropriate higher-tier Parts (Capability, product, or service). Hence, there is a need to identify and classify the lower-tier Part under appropriate higher-tier Parts to approximate the event hierarchy classification.

FIG. 1B provides a block diagram of a connected environment 100-1, in accordance with an example implementation of the present subject matter. The connected environment 100-1 represents a comprehensive network of interconnected systems, devices, and services that collectively support the operation and management of an offering. The offering may be onboarded with a unified platform 120 and the unified platform 120 may be responsible for supporting and maintaining distinct functions in relation to the offering. The unified platform 120 may incorporate technologies such as cloud computing, containerization, microservices architecture, and the like.

In an example, the unified platform 120 may be hosted by a system 122. The system 122 may include any type of equipment that may be used to implement, operate, or interface with the unified platform 120. The system 122 may be, for example, workstations, personal computers, mobile devices, servers, hosts, nodes, or remote computing terminals.

The unified platform 120 may connect various discrete ecosystems, each of which may focus on different specific aspects of the offering, such as development, deployment, operation, and user interaction. The operation of the unified platform 120 involves analysis of large amounts of data streams captured from the distinct ecosystems to identify events occurring at the distinct ecosystems for processing by the unified platform 120. The unified platform 120 may implement autonomous processing of the events to generate items of interest to one or more entities operating in distinct ecosystems.

The discrete ecosystems, while distinct in their primary functions, may be intricately linked through the unified platform 120. In an example, the discrete ecosystems may include a development ecosystem 124, an operation ecosystem 126, a user ecosystem 128, and a customer relationship management (CRM) ecosystem 130. The discrete ecosystems, while operating independently to some degree, are interconnected through the unified platform 120, allowing for a holistic approach to managing the offering's lifecycle and ensuring consistent performance and user experience across all aspects of the offering. The system 122 hosting the unified platform 120 may be connected with different computing devices hosted across the connected environment 100-1 through a network (not shown).

The system 122 may be communicatively coupled to computing devices (not shown) associated with each of the discrete ecosystems either through a direct communication link, or through multiple communication links of the network. The network may be a wireless or a wired network, or a combination thereof. The network may be a collection of individual networks, interconnected with each other and functioning as a single large network. Examples of such individual networks include, but are not limited to, Global System for Mobile communication (GSM) network, Universal Mobile Telecommunications System (UMTS) network, Long Term Evolution (LTE) network, personal communications service (PCS) network, Time-division multiple access (TDMA) network, Code-Division Multiple Access (CDMA) network, next-generation network (NGN), public switched telephone network (PSTN), and Integrated Services Digital Network (ISDN). Depending on the terminology, the network includes various network entities, such as gateways and routers; however, such details have been omitted to maintain the brevity of the description.

Any number or type of data streams generated by the distinct ecosystems may be acted upon by embodiments of the present subject matter. The development ecosystem 124 may inhabit a plurality of developer entities 124-1 and may generate data streams comprising developer data 124-2. The development ecosystem 124 may be related to aspects of building the offering and various components related to the offering. For example, the development ecosystem 124 may encompass various tools, platforms, and processes used in the creation and maintenance of the offering. The tools and platforms may include integrated development environments (IDEs), version control systems, continuous integration/continuous deployment (CI/CD) pipelines, code review tools, and testing frameworks. The developer entities 124-1 may represent individual software engineers, development teams, or automated systems involved in the coding, testing, and deployment processes. Further, the developer data 124-2 generated in the data streams originating from the developer entities may include code commits, pull requests, build logs, test results, code coverage reports, and performance profiling data. The developer data 124-2 may provide information regarding the evolution of the offering, identifying potential issues early in the development cycle, and maintaining code quality.

Further, the operation ecosystem 126 may inhabit a plurality of operation entities 126-1 and may generate data streams comprising operation data 126-2. The operation ecosystem 126 may be related to aspects of deployment, monitoring, updating, and maintenance of the offering in the connected environment 100-1. For example, the operation ecosystem 126 may include tools, platforms, and processes used in infrastructure management (Cloud platforms, on-premises servers, containerization technologies (e.g., Docker, Kubernetes), and virtual machines), monitoring and alerting systems (Prometheus, Grafana, Nagios, Datadog, and the like), log management solutions (Centralized logging systems such as ELK (Elasticsearch, Logstash, Kibana) stack or Splunk), performance optimization tools, and the like. The operation entities 126-1 may represent individual system administrators, DevOps engineers, and site reliability engineers. Further, the operation data 126-2 generated in the data streams originating from the operation entities may include server logs, performance metrics, resource utilization statistics, container orchestration metrics, CDN (Content Delivery Network) edge server performance, and incident reports. The operation data 126-2 may assist in determining the reliability, scalability, and efficiency of the offering in real-world usage scenarios.

The user ecosystem 128 may inhabit a plurality of user entities 128-1 and may generate data streams comprising user data 128-2. The user ecosystem 128 may be related to aspects of interaction of end-users with the offering. For example, the user ecosystem 128 may include various client devices, operating systems, network conditions, and the like. The user entities 128-1 may represent the end-users. Further, the user data 128-2 generated in the data streams originating from the user entities 128-1 may include usage patterns, feature adoption rates, user feedback, and error reports. The user data 128-2 may provide information useful for understanding user behaviour, identifying areas for improvement, and guiding future development priorities.

The CRM ecosystem 130 may inhabit a plurality of CRM entities 130-1 and may generate data streams comprising CRM data 130-2. The CRM ecosystem 130 may be related to aspects of managing relationships and interactions of customers with the offering. For example, the CRM ecosystem 130 may include customer support platforms, sales management tools, marketing automation platforms, chatbot systems, user journey mapping tools, and the like. The CRM entities 130-1 may include sales representatives, technical support engineers, feedback analysts, service chatbots, Artificial Intelligence (AI) assistants, and the like. Further, the CRM data 130-2 generated in the data streams originating from the CRM entities 130-1 may include customer inquiries, support tickets, sales data, and sentiment analysis metrics. The CRM data 130-2 may provide information useful for understanding customer needs, improving support processes, and identifying upselling or cross-selling opportunities.

The unified platform 120 hosted by the system 122 is thus configured to interface with diverse data sources, such as the various entities in the discrete ecosystems (the development ecosystem 124, the operation ecosystem 126, the user ecosystem 128, and the CRM ecosystem 130 across the connected environment 100-1. The unified platform 120 thus allows for extracting relevant information from heterogeneous data streams originating from the various entities in the discrete ecosystems of the connected environment 100-1. The system 122 may be configured to integrate the heterogeneous data from the various discrete ecosystems and understand complex relationships and contexts within the heterogenous data, potentially uncovering insights that might not be apparent through the traditional data analysis techniques. The context and insights may alert towards the requirement of certain modifications in one or more of the different aspects of the offering. Further, the heterogenous data and the derived insights and context may be used to generate product parameter seeds. The product parameter seeds may be executable to generate or update one or more aspects related to the offering. The system 122 may also classify the generated or updated aspects related to the offering. The present subject matter outlines an application of the inventive method for the Software-as-a-Service (Saas) industry, but it is not limited to this industry.

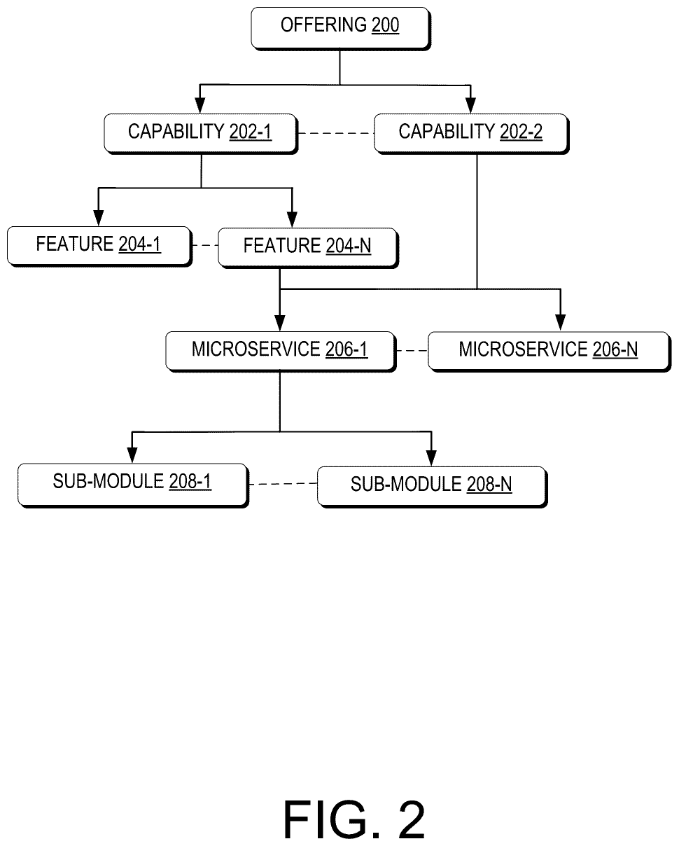

FIG. 2 illustrates a block diagram of a comprehensive framework comprising hierarchical product parameters for an offering, in accordance with an example implementation of the present subject matter. The comprehensive framework standardizes a hierarchy of product parameters ensuring consistency and coordination across all entities and data from the discrete ecosystems in the unified platform 120 (as discussed with reference to FIG. 1B). Each element in the hierarchy may be referred to as a hierarchical product parameter. The structure and specific product parameters of the hierarchy may vary depending on a type of the offering 200. Though the description here focuses on software-based offerings, the comprehensive framework may be adapted for other products or services.

The offering 200 forms the foundational entity for which the hierarchy is constructed. The offering 200 is defined as a unit of profit and loss, identity, onboarding, and contracting purposes. The offering 200 may encompass multiple hierarchical product parameters, arranged in a top-down structure of increasing granularity. At the highest level of granularity, the offering 200 may include capabilities such as capabilities 202-1, 202-2, . . . , and 202-N, where N is a natural number. The capabilities 202-1, 202-2, . . . , and 202-N may be singly referred to as a capability 202 and collectively referred to as capabilities 202. The capability 202 represents a core functional unit with which an end user may directly interact. For example, in a customer relationship management (CRM) software offering, the capabilities 202 may include “Contact Management,” “Sales Pipeline,” or “Email Marketing.”

At the next level of granularity, each capability 202 may be composed of one or more features 204, such as features 204-1, . . . , and 204-N. The features 204-1, . . . 204-N may hereinafter be singly referred to as a feature 204 and collectively as features 204. The feature 204 is another hierarchical product parameter having a specific functionality within a capability 202. The feature 204 is typically not directly interacted with by the end-user but may be essential to the operation of the capability 202. For instance, within the “Contact Management” capability as discussed above, features may include “Contact Deduplication,” “Custom Fields,” or “Activity Tracking.”

In software-based offerings, the capabilities 202 and/or the features 204 are often supported by backend constructs, which form additional levels in the hierarchy of product parameters. The additional levels may include microservices 206-1, 206-2, . . . 206-N and sub-modules 208-1, . . . 208-N. The microservices 206-1, 206-2, . . . 206-N may hereinafter be singly referred to as a microservice 206 and collectively as microservices 206. Similarly, the sub-modules 208-1, . . . 208-N may hereinafter be singly referred to as a sub-module 208 and collectively as sub-modules 208. The microservices 206 and the sub-modules 208 may represent the technical implementation of the higher-level functionalities. For instance, the “Contact Management” capability, as discussed above, may be supported by microservices 206 such as “Contact Data Storage”, “Contact Search”, and “Contact Synchronization”. The microservices 206 may further rely on sub-modules 208 such as database connectors, caching mechanisms, or third-party Application Programming Interface (API) integrations.

The microservice 206 may be a deployable unit of software that may support one or more features 204 or contribute to a capability 202. As illustrated in FIG. 2, the feature 204-N may be based on the microservice 206-1. In another example implementation as depicted in FIG. 2, the capability 202-N may be formed based on a combination of microservice 206-1 and the microservice 206-N. Further, the microservice 206-1 may be implemented using the sub-module 208-1 and the sub-module 208-N. The sub-module 208 may be meant as part of an entity in the connected environment 100, but not the entity as a whole.

For software-based offerings, the offering 200 may have an Application Programming Interface (API) namespace and associated service level agreements (SLA). The capability 200 may be conceptualized as a set of entities (noun) and activities (verbs) associated with the each provided entity. Each capability 202 may have configurable elements that manifest as one or more features 204 or contribute to the capability 202. Extending the noun/verb analogy used above, the feature 204 may define specific attributes (adjectives) of functions performed at an entity within one of the distinct ecosystems explained in relation to FIG. 1.

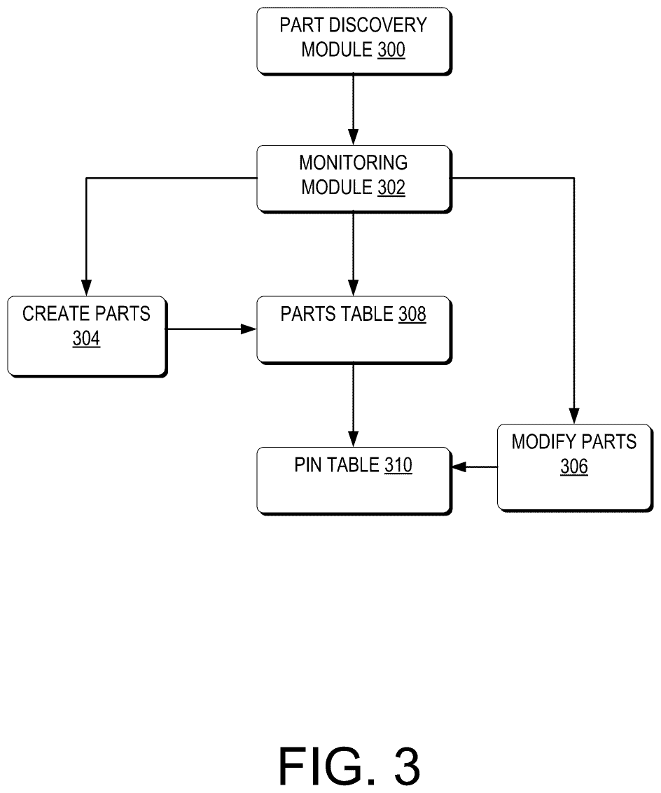

In accordance with an exemplary embodiment, a Part Discovery module 300 performs monitoring of parts functioning, discovering new Parts in event hierarchy components, and modifying the existing parts. The Part Discovery module 300 (FIG. 3) comprises a monitoring component 302 that keeps track of all the actions taken on the Part hierarchy during operation both at the developers' front and at the customers' end. The Features are the deliverables at the customer end, which can be modified at customers' ease.

In an embodiment, the Part Discovery module 300 comprises a part generation module 304, wherein the new part generation is dependent on extracting clues (meaningful data extracts) by collecting data from disparate sources used in the enterprise and converting them into a clue having a similar format to the part in the event hierarchy. These clues finally materialize into Parts (by Partitioning and merging the extracted clues) in the Developer-Revenue system. The Part Discovery module 300 facilitates the auto-discovery of Parts without the customer having to create them manually. The Parts generated are stored in Parts table 308 (wherein the table is a database constituent).

A part modifying component 306 comprising a pinning module that pins (records) every action and stores them in a database. When a user modifies a Part in terms of changing the dependency of Features with Capability by removing the links or adding new links, deleting the existing links with the Capabilities, or adding, modifying, or deleting the existing components, then all such actions are pinned by the Part Discovery module 200. The pinned records are stored as ‘Part-pins’ in Pin Table 310. Further, in the Part generation module, a merging component considers the clues from standard sources and the Pin table 310 to reconcile differences and determine whether to skip creating a Particular Part.

The generation of Parts (both Dev Parts and Rev Parts) and modifying activities performed on Parts generally affect the existing product or service hierarchy. To approximate the classification of generated Features through pinned actions or generation of new Parts, the Part Discovery module implements host extraction of each Feature such that the source of such Feature is determined, and such Feature is grouped with appropriate higher-tier Part (Capability or Product) in the Part hierarchy. The lower-tier Part in the Part hierarchy contains an API defined by a URL.

In one of the embodiments of the present specification, a host extraction unit is integrated with a Part Discovery module wherein the host extraction unit extracts host data from the API or by extracting API specification files or routing rules and combining the specification data to determine host information; or by extracting host information from an extractor of the clue processing module and a pinned value from a Pin table of a pinning module and reconciling the discovered host information with the pinned value.

In accordance with one of the embodiments, APIs are described by a URL, wherein the URL contains the domain data, and the domain is known as the host of the API. This host is the entity through which the API command is transferred or to which the API is routed. The Part Discovery module executes the host extraction through the host extraction unit to solve the existing issues of classifying (linking) the lower-tier Part (Features) to higher-tier Parts (Capabilities or Products) or linking the generated lower-tier Part to other components at the same level (parent Feature-sub-Feature classification) in the hierarchy.

The host extraction unit extracts the host data from the API path since most APIs specify the host (URL comprising domain) in the API path. A clue generator of the Part generation module consists of clues (like Rev clues, wherein a set of Rev clues are extracted, Partitioned, and merged to form Rev Parts) wherein each clue contains API data wherein each API specifies the host. Suppose a host is not specified in the API. The host extraction unit extracts data from API specification or routing rules files, which can further determine the API host and transform the extracted data into Part clues. Through this, the Part Discovery module allows for a more granular specification of API-related information and stores such host information, which allows for instant extraction of the host of the Part clue during the next run of the Part Discovery module.

In accordance with one of the embodiments, if the host is modified by the user (developer or customer), then the host extraction unit extracts a host information from an extractor of the clue processing module and extracts a pinned value from a Pin table of a pinning module, wherein the host extraction unit reconciles the host information from the extractor of the clue processing module with the pinned value form the Pin table of the pinning module.

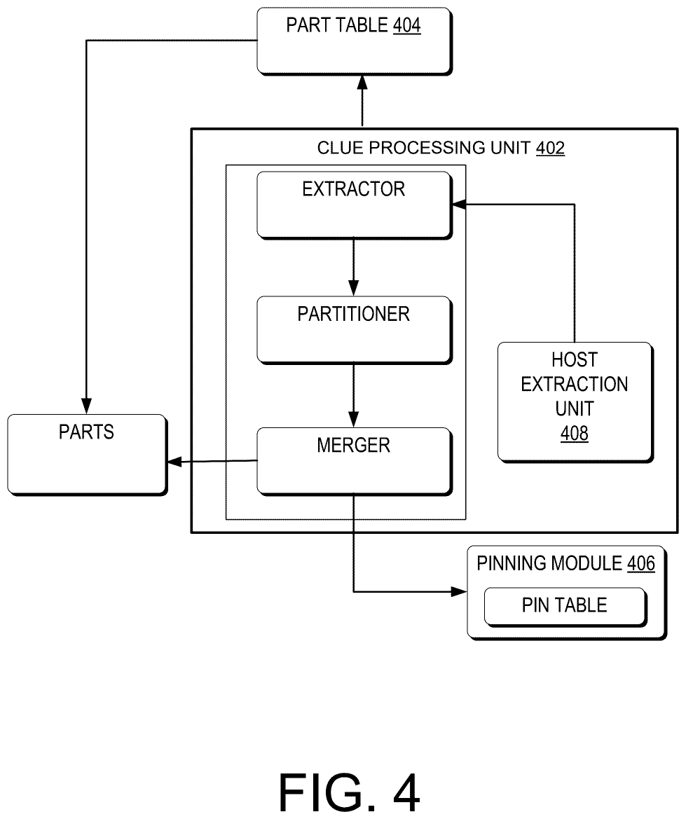

In accordance with another exemplary embodiment, host extraction (FIG. 4) approximates Capabilities by grouping the Features within the context of an API host. This improves the accuracy of the Part Discovery module and helps users group the generated Parts. A host extraction unit 408 is integrated with the Clue processing unit 402 to approximate the classification or grouping of lower-tier Parts (Features) in a Part hierarchy (related to a product/service) with appropriate higher-tier Parts (Capability or product) of the hierarchy, wherein the host extraction unit 408 extracts host data from API itself that is defined in the lower-tier Part; or by extracting data from API specification files or the routing rules files, and these extracted data are transformed into Rev clues that can further determine the API host; or by extracting the records of Pin table of the pinning module 406.

APIs are described by a URL containing the domain data, and the domain is known as the API host. This host is the entity through which the API command is transferred or to which the API is routed. The Part Discovery module uses host extraction unit 408 to solve the existing issues of classifying (linking) the Features to the higher-tier Parts (Capabilities) or other Features. The host is extracted from the API path or through the pinned value recorded in the Pin table of the pinning module 406.

The Part Discovery module has limitations in identifying higher-tier (in Part hierarchy structure) components in the Part hierarchy, especially on the ‘Rev’ side (Rev Parts). The Rev side Parts discovery is focused on extracting information from API specifications and documentation, and Rev clues often contain information about the host of a given API. Extracting host-related information for the Rev clues can approximate the Parts classification on the Rev side.

The host extraction unit 408 extracts the host data from the API since most APIs specify the host (URL comprising domain). The clue processing unit 402 generates Rev clues (wherein a set of Rev clues are extracted, Partitioned, and merged to form Rev Parts), and a Rev clue may contain API Path wherein each API specifies the host. Suppose a host is not specified in the API, then the host extraction unit 408 extracts data from API specification files or the routing rules files to determine the host, and these extracted data are transformed as clues. Such specification clues obtained are combined to determine the Feature's host. Through this, the Part Discovery module allows for a more granular specification of API-related information and stores such host information, which allows for instant extraction of the host of the Part clue during the next run of the Part Discovery module.

In another embodiment, if the user modifies the host, then the host extraction unit 408 extracts the host information from an extractor of a clue processing unit 402 and extracts pinned values from the Pin table of a pinning module 406, wherein the Pin table comprises all the pinned values stored as Part-pins, wherein the host extraction unit 408 reconciles discovered host information from the extractor of the clue processing unit 402 with the pinned value form the Pin table of the pinning module 406.

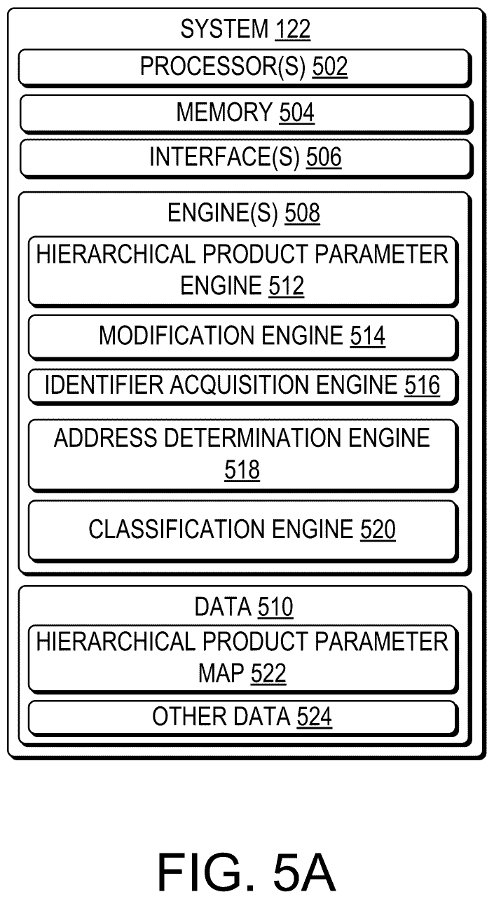

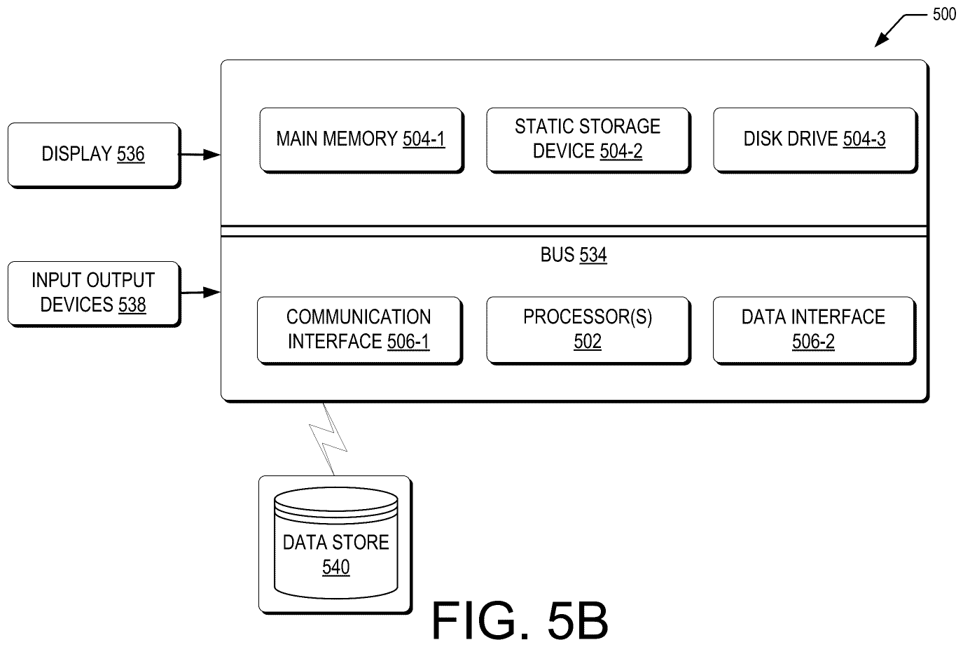

FIG. 5A illustrates schematics of a system for classifying hierarchical product parameters, in accordance with an example of the present subject matter. For the sake of brevity, FIG. 5A has been explained in conjunction with FIGS. 1 to 4. As already described, the system 122 may host the unified platform 120 and the unified platform 120 may communicate with the discrete ecosystems in the connected environment 100-1. FIG. 5A illustrates additional aspects of the invention, with reference numbers and elements that may be drawn from FIGS. 1 to 4 as explained above. Similar or identical components may retain the same reference numbers across figures for consistency.

The system 122 may include a processor(s) 502 to run at least one operating system and other applications and services. The system 122 may further include a memory 504 coupled to the processor(s) 502, interface(s) 506, engine(s) 508, and data 510.

The processor(s) 502, amongst other capabilities, may be configured to fetch and execute computer-readable instructions stored in the memory. The processor(s) 502 may be implemented as one or more microprocessors, microcomputers, microcontrollers, digital signal processors, central processing units, state machines, logic circuitries, and/or any devices that manipulate signals based on operational instructions. For instance, the processor(s) 502 may include specialized AI accelerators or Graphic Programming Units (GPUs) optimized for machine learning tasks. The functions of the various elements shown in the figure, including any functional blocks labelled as “processor(s)” or “processing unit”, may be provided through the use of dedicated hardware as well as hardware capable of executing machine readable instructions.

When provided by the processor(s) 502, the functions may be provided by a single dedicated processor, by a single shared processor, or by a plurality of individual processors, some of which may be shared. Moreover, explicit use of the term “processor(s)” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. For example, the system 122 may utilize FPGAs for real-time data processing and ASICs for specific, high-performance tasks like encryption or data compression. Other hardware, conventional and/or custom, may also be included. The processor(s) 502 may include routines, programs, objects, components, data structures, and the like, which perform particular tasks or implement particular abstract data types. The processor(s) 502 may further include modules that supplement applications on the system 122, for example, modules of an operating system. Further, the processor(s) 502 may be implemented in hardware, instructions executed by a processing unit, or by a combination thereof.

The memory 504 may be coupled to the processor(s) 502 and may, among other capabilities, provide data and instructions for performing different functions. The memory 504 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 504 may store the information received and in possession of the system 122 as data 510.

The interface(s) 506 may include a variety of machine-readable instructions-based interfaces and hardware interfaces that allow the system 122 to interact with different components, such as the processor(s) 502, the memory 504, the engines 508, and the data 510. Further, the interface(s) 506 may enable the system 122 to communicate with computing devices, for example, the computing devices in the discrete ecosystems communicate with the system 122, web servers, and external repositories. The interface(s) 506 may facilitate multiple communications within a wide variety of networks and protocol types, including wireless networks, wireless Local Area Network (WLAN), RAN, satellite-based network, and the like. For instance, the interface(s) 506 may support protocols such as Hyper Text Transfer Protocol Secure (HTTPS), Message Queuing Telemetry Transport (MQTT), and Remote Procedure Calls (RPCs).

The engine(s) 508 may be implemented as a combination of hardware and firmware or software. In examples described herein, such combinations of hardware and firmware may be implemented in several different ways. For example, the firmware for the engine(s) 508 may be processor executable instructions stored on a non-transitory machine-readable storage medium and the hardware for the engine(s) 508 may include a processing resource (for example, implemented as either a single processor or a combination of multiple processors), to execute such instructions.

In the present examples, the machine-readable storage medium may store instructions that, when executed by the processor(s) 502, implement the functionalities of the engine(s) 308. In such examples, the system 122 may include the machine-readable storage medium storing the instructions and the processor(s) 502 to execute the instructions. In other examples of the present subject matter, the machine-readable storage medium may be located at a different location but accessible to the system 122 and the processor(s) 502. The engine(s) 508 may include a hierarchical product parameter engine 512, a modification engine 514, an identifier acquisition engine 516, an address determination engine 518, and a classification engine 520 coupled with each other. The engine(s) 508 correspond to the part discovery module.

The system 122 may further include data 510, that serves, amongst other things, as a repository for storing data that may be fetched, processed, received, or generated by the engine(s) 508. The data 510 may include hierarchical product map 522, and other data 524. The hierarchical product map 522 corresponds to the part table 308. In an example, the data 510 may be stored in the memory 504.

In an example implementation, the hierarchical product parameter engine 512 may obtain hierarchical product parameters associated with an offering within a hierarchy of operational factors. The hierarchical product parameter is referred to as a part of the offering, such as a part of a product or a part of a service. The hierarchical product parameters may include higher-tier hierarchical product parameters and lower-tier hierarchical product parameters of the offering. In an example, the obtained hierarchical product parameters may include at least one lower-tier hierarchical product parameter of the offering. The lower-tier hierarchical product parameter may refer to a specific element or attribute within an offering's hierarchical structure that exists at a lower level of granularity. For example, the lower-tier hierarchical product parameter may be a feature, a sub-feature, or even a more granular element like a microservice or a sub-module.

In an example, the hierarchical product parameters may be generated by a product parameter seed. The product parameter seed is referred to as a clue The product parameter seed may be executable to obtain a hierarchical product parameter for the offering operating in the unified platform based on a data retrieval signal. The data retrieval signal may be received from an entity operating in association with the unified platform 120 in the connected environment 100-1. The entity may be associated with the offering 200 and may be one of the developer entities 124-1, the operator entities 126-1, the user entities 128-1, and the CRM entities 130-1. For example, a developer entity 124-1 may send a data retrieval signal to gather information about recent code commits and associated performance metrics.

The obtained lower-tier hierarchical product parameter may be defined with an identifier. For example, the identifier may be a unique tag, a code, or a label, assigned to the lower-tier hierarchical product parameter to distinguish it from an other lower-tier hierarchical product parameter and to indicate the position of the lower-tier hierarchical product parameter within the hierarchy of operational factors. In an example, a set of identifiers may be associated with each lower-tier hierarchical product parameter. The identifier may enable categorization and organization, allowing for efficient retrieval and management of information related to each hierarchical product parameter. The identifier is referred to as an Application Programming Interface (API) path.

In an example implementation, the modification engine 514 records and updates modifications to the hierarchical product parameter in the hierarchy of operational factors based on a request received from a user. Once a modification request is received, the request for the modification of the hierarchical product parameter may be processed to obtain a modified hierarchical product parameter. The modified hierarchical product parameter represents the user's preferred values for the hierarchical product parameter. The modified hierarchical product parameter with the modifications is then recorded in a pin table after validation of the user preferred values. The pin table is a specialized database structure designed to efficiently record and track modifications to hierarchical product parameters. In an example, the pin table may be stored in other data 524.

The modification engine 514 may capture and log every action performed on each hierarchical product parameter, regardless of its tier or position in the hierarchy. In an example, the user actions may include modifications carried in the dependencies between hierarchical product parameters, such as changing relationships between lower-tier and upper-tier hierarchical product parameters or altering connections between hierarchical product parameters on the same tier. In another example, the user actions may include modifications in the hierarchical product parameters, such as deleting existing links or connections between hierarchical product parameters or establishing new connections or relationships between hierarchical product parameters. In another example, the user actions may include modifications in attributes of the hierarchical product parameters, such as names, descriptions, or any other defined characteristics of the hierarchical product parameter.

In an example implementation, on obtaining the lower-tier hierarchical product parameter, the identifier acquisition engine 516 retrieves the identifier associated with lower-tier hierarchical product parameter. The identifier acquisition engine 516 may access the identifier and fetch information about the identifier. The information may be related to a hierarchical structure and a location of the lower-tier hierarchical product parameter. The location, indicated by the identifier, may refer to a specific place or position that the lower-tier hierarchical product parameter occupies within the hierarchy of operational factors. The location information is important for understanding how different hierarchical product parameters relate to each other and how they fit into the hierarchy of the offering.

As discussed above, the identifier may be referred to as the Application Programming Interface (API) path. The API, or Application Programming Interface, is a set of protocols, routines, and tools for building software applications. Further, API paths are specific routes or endpoints within the API that correspond to particular functionalities or resources of the offering. The API paths are typically structured in a way that reflects the hierarchical nature of the offering's structure. In an example, within a customer relationship management system, an API path for accessing contact information may be “/api/contacts”, while a more specific API path for importing contacts may be “/api/contacts/import”. In an example, the API path may be defined as URLs (Uniform Resource Locators), which are addresses used to locate and access resources. In the context of APIs, the URLs may serve as unique identifiers for specific functionalities or data points within the offering. The structure of the URLs may mirror the hierarchical structure of the offering itself, with each segment of the path representing a different level or category within the hierarchy.

As discussed above, once retrieved, the identifier may provide valuable information about the structure and organization of the offering. In an example, the identifier may be used to map out the complete hierarchy of the product's features and functionalities. The identifier may also help in understanding the relationships between different hierarchical product parameters of the offering and to locate specific features or functionalities within the overall hierarchy of operational factors.

In an example implementation, the address determination engine 518 may determine an address associated with the identifier. The address may refer to a specific piece of information extracted from the identifier that indicates a logical or physical location where the associated hierarchical product parameter is hosted or managed within the system. The host may be referred to as the address, which typically refers to the server, domain, or network entity responsible for providing or managing the resource associated with the identifier. In an example, in the URL “https://api.example.com/v1/users”, the host would be “api.example.com”. The address determination engine 518 may extract and interpret the specific information from the retrieved identifier to establish a logical location or origin of the associated hierarchical product parameter within the system architecture.

The address or host associated with each identifier may be determined by analyzing the structure and content of the identifier to extract the relevant host information. The determination of the address may be done through various approaches, depending on the format and structure of the identifier used in the system 122. In an example, when the host information is explicitly present in the identifier itself, then the address associated with the identifier may be determined by parsing the identifier. For instance, if the identifiers are API paths or URLs, the address determination engine 518 may extract the domain portion as the host. For example, the determined host address for an identifier “https://services.myproduct.com/capabilityl/feature2” may be “services.myproduct.com”.

Such an approach for determining the address is computationally efficient. Direct extraction is typically a fast operation, requiring minimal processing power and time. The approach may be particularly beneficial when dealing with large sets of identifiers or when rapid processing is necessary. Further, it also reduces the chances of errors that might occur in more complex address determination methods. When the address is explicitly specified, there's less room for misinterpretation or miscalculation. In addition, by allowing for explicit address specification within identifiers, the system may process quickly and easily.

However, in some scenarios, the host information might not be explicitly present in the identifier itself. In such scenarios, the address determination engine 518 may determine the address associated with the identifier based on additional configuration files, lookup tables, or other data sources mapping the identifier to its corresponding host. For example, an identifier may be a shortened path like “/c1/f2”, and the address determination engine 518 may use predefined mapping rules to determine that this path corresponds to a specific host, such as “api.myproduct.com”.

In an approach, when the address is not explicitly specified in the retrieved identifier, the address determination engine 518 may extract an information associated with the address and determine the address based on specification files, or configuration files, or both. In an example, specification files may be referred to as formal documents describing the structure, endpoints, parameters, and responses of an Application Programming Interface (API). The specification files may provide detailed information about the structure and usage of the API. The configuration files, on the other hand, may be routing-rule documents indicating URL patterns and information associated with the address. The configuration files may provide information regarding handing different requests and routing the requests to the appropriate resources. The configuration files may contain mappings between URL patterns and the corresponding handlers or resources. Thus, the specification files and the configuration files contain valuable information about the structure and routing of the API, which may be used to infer the address when the address has not been explicitly specified in the identifier.

In an example, the address determination engine 518 may combine the pieces of information extracted from the specification and configuration files to construct the complete address. For instance, the specification file may provide a general structure for the address, while the configuration file may provide specific mappings for certain types of identifiers. The merging process may apply the specific mappings within the context of the general structure to produce the final address. This merging step also allows for a level of flexibility in how addresses are structured. Different parts of the address might come from different sources, allowing for a modular approach to address construction. This could be particularly useful in a system that needs to handle a wide variety of hierarchical product parameters with different addressing needs. For instance, if the address determination engine 318 extracts a base path “/api/v1” from the specification file and a service identifier “users” from the configuration file, it may merge the extracted information to form the address “/api/v1/users”.

Such process of obtaining files, extracting information, and merging it to identify the address may be particularly useful in complex systems where addresses may not always be explicitly defined or may be constructed dynamically based on various rules and configurations. It allows the system to be more flexible and adaptable, capable of working with different address structures and conventions without requiring explicit address definitions for every identifier. By using specification and configuration files to determine addresses, the system can also maintain a level of flexibility and scalability.

In another approach, the address determination engine 518 extracts the information associated with the address from the product parameter seed. Further, the address determination engine 518 extracts the information associated with the address from recorded values of the lower-tier hierarchical product parameter stored in the pin table. Subsequently, the address determination engine 518 may determine the address associated with the identifier based on combining the information extracted from the product parameter seed and the pin-table. Such an approach ensures that the system always has the updated and accurate information about hierarchical product parameter's location and value within the offering's structure, even as the offering evolves and is customized by users or updated by the system.

In an example implementation, the address determination engine 518 may extract the information associated with the address from the hierarchical product parameter map. The hierarchical product parameter map may include user-provided names for address or a group of address. In an example, the group of address may include a common user-provided name. The modification engine 514 may allow the users to interact with the hierarchical product parameters and the extracted host information. In an example, the system 122 allows the users to unite hierarchical product parameters across different hosts. The ability of users to provide better host information may facilitate the system to either use a name provided by the users for the host or view different hosts as one host (a host group) when multiple hierarchical product parameters are united. In an example, the users may be allowed to provide feedback to the system to customize the functional settings of the system to either specify if the host information is to be ignored altogether or to specify that some hosts, resulting from uniting multiple hierarchical product parameter, are same. For example, the settings may be set as host1 and host2 are the same, but host3 is different.

The importance of determining the address lies in its role in organizing and categorizing the hierarchical product parameters. By identifying the host for each hierarchical product parameter, the system 122 may group related and relevant hierarchical product parameters together and facilitate proper routing of requests or management of resources. For example, in a microservices architecture, different capabilities or features of a product might be hosted on separate services, each with its own host. By determining the host for each identifier, the system can accurately classify and organize the product parameters according to the underlying service architecture. This is crucial for maintaining a coherent and manageable hierarchy of operational factors for the offering.

The classification engine 520 may then classify the lower-tier hierarchical product parameter under an appropriate hierarchical product parameter based on the determined address. In an example, the appropriate hierarchical product parameter may be a higher-tier hierarchical product parameter. In another example, the appropriate hierarchical product parameter may be an other lower-tier hierarchical product parameter. The classification process is essential for maintaining order and coherence within a hierarchical system, allowing for efficient navigation and understanding of the relationships between different hierarchical product parameters.

In an example implementation, the information derived from the identifiers and addresses of the lower-tier hierarchical product parameters may be used to infer and construct higher-tier hierarchical product parameters. For instance, patterns and commonalities among the lower-tier hierarchical product parameters may be identified to group them logically into capabilities or products. In an example, multiple features with similar API path structures or shared domains may be grouped under a common capability.

Further, in scenarios where appropriate user-provided information is available, the classification engine 520 may incorporate the user-provided information to refine or override the automatically generated classifications. For example, if a user specifies that certain features should be grouped under a specific capability, the system may prioritize the user-provided information over the automatically inferred relationships.

The classification technique is important because it allows for more granular organization and management of the offering. By classifying the lower-tier hierarchical product parameter under an appropriate hierarchical product parameter, the system 122 may be able to manage, monitor, and optimize the hierarchical product parameters efficiently. In addition, the system 122 may be able to better understand the internal structure of features and may provide more detailed insights into how different hierarchical product parameters of a product or service are used. This, in turn, may enable more precise tracking, monitoring, and management of hierarchical product parameters.

In an example, the classification engine 520 may establish a hierarchical link between the classified lower-tier hierarchical product parameter and the appropriate hierarchical product parameter. The hierarchical may represent a logical relationship between the classified lower-tier hierarchical product parameter and the appropriate hierarchical product parameter. For instance, a structured relationship may be created within the product or service hierarchy between the classified lower-tier hierarchical product parameter and the appropriate hierarchical product parameter.

The hierarchical link may enable traceability between different levels of the hierarchy of operational factors for the offering. For instance, users may be able to navigate from the sub-feature up to its parent feature or from the feature up to its capability, understanding the context and broader functionality it belongs to. In an example, the hierarchical link may be represented visually, in user interfaces or documentation, illustrating how the lower-tier hierarchical product parameter fits within the higher-tier hierarchical product parameter. Accordingly, by establishing the hierarchical link, the system 122 creates a clear, structured relationship between the classified lower-tier hierarchical product parameter and the appropriate hierarchical product parameter, enhancing the overall organization and understanding of the product or service architecture.

In an example, the system 122 may update a hierarchical product parameter map to reflect the structured relationship, i.e., established hierarchical link between the classified lower-tier hierarchical product parameter and the appropriate hierarchical product parameter. The hierarchical product parameter map is a structured representation of the hierarchical product parameters and their relationships within the hierarchy of operational factors for the offering. Keeping the hierarchical product parameter map updated ensures that it accurately reflects the current state of the offering's structure. As the offering evolves and the hierarchical product parameters are continuously evaluated and classified, the hierarchical product parameter map may be regularly updated to maintain its accuracy and relevance. Additionally, by updating the hierarchical product parameter map based on classification, the system 122 ensures that there is always an accurate, real-time representation of the offering's structure, which is vital for effective management and development of the offering in the unified platform.

The present subject matter thus provides a flexible and efficient approach for automatically classifying hierarchical product parameters based on the set of identifiers and updating the hierarchy of operational factors while maintaining data integrity and relationships. The present subject matter improves the accuracy of the classification by extracting the host information from API paths and classifying lower-tier hierarchical product parameters under appropriate higher-tier hierarchical product parameters. Further, the present subject matter offers significant benefits in terms of management, development, and communication of the offering by automatically classifying and linking the hierarchical product parameters.

By accurately classifying and organizing the features and sub-features, the present subject matter provides valuable insights into product usage, customer needs, and potential areas for improvement or new feature development for the offering. The accurate classification of features and sub-features enables support teams to more quickly identify and resolve customer issues by linking them to specific hierarchical product parameters of the product or service. The automated nature of the classification process makes it easier to scale across multiple products and services, and to maintain the hierarchy with the evolution of the offerings over time. Further, the classification method integrates seamlessly with the existing unified platform, allowing for better coordination between development, operations, and customer-facing teams. These technical advantages collectively contribute to a more efficient, reliable, and accurate system for classifying the hierarchy of operational factors for the offering, addressing key challenges faced in conventional systems.

FIG. 5B illustrates a block diagram of a computing system 500 suitable for implementing an embodiment of the present subject matter. Computing system 500 may include a bus 534 or other communication mechanism for communicating information, which interconnects subsystems and devices, such as processor(s) 502, main memory 504-1 (e.g., RAM), static storage device 504-2 (e.g., ROM), disk drive 504-3 (e.g., magnetic or optical), communication interface 506-1 (e.g., modem or Ethernet card), display 536 (e.g., CRT or LCD), input device 538 (e.g., keyboard, and cursor control).

According to one embodiment of the present subject matter, the computing system 500 performs specific operations by the processor(s) 502 executing one or more sequences of one or more instructions contained in the main memory 504-1. Such instructions may be read into the main memory 504-1 from another computer readable/usable medium, such as the static storage device 504-2 or disk drive 504-3. In alternative embodiments, hard-wired circuitry may be used in place of or in combination with software instructions to implement the invention. Thus, embodiments of the present subject matter are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to the processor(s) 502 for execution. Such a medium may take many forms, including but not limited to, non-volatile media and volatile media. Non-volatile media includes, for example, optical or magnetic disks, such as disk drive 504-3. Volatile media includes dynamic memory, such as main memory 504-1. A data store 540 may be accessed in a computer readable medium using a data interface 506-2.

Common forms of computer readable media includes, for example, a floppy disk, a flexible disk, a hard disk, a magnetic tape, any other magnetic medium, a CD-ROM, any other optical medium, punch cards, a paper tape, any other physical medium with patterns of holes, RAM, PROM, EPROM, FLASH-EPROM, any other memory chip or cartridge, or any other medium from which a computer can read.

In an embodiment of the present subject matter, execution of the sequences of instructions to practice the present subject matter is performed by a single computing system 500. According to other embodiments of the present subject matter, two or more computing systems 500 coupled by communication link (e.g., LAN, PTSN, or wireless network) may perform the sequence of instructions required to practice the invention in coordination with one another.

The computing system 500 may transmit and receive messages, data, and instructions, including program, i.e., application code, through communication link and communication interface 506-1. Received program code may be executed by the processor(s) 502 as it is received, and/or stored in the disk drive 504-3, or other non-volatile storage for later execution.

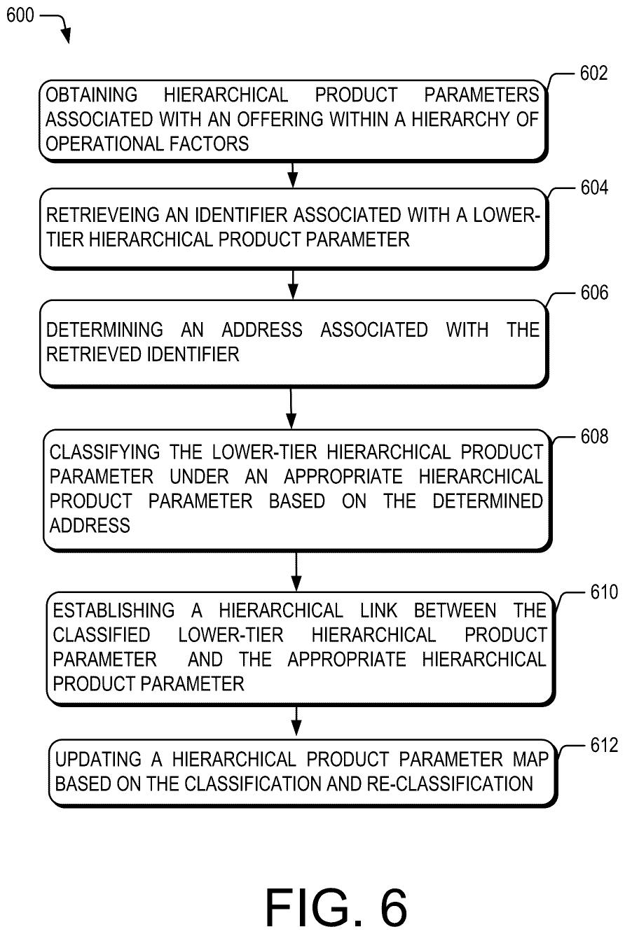

FIG. 6 illustrates a block diagram of a method 600 for facilitating classification of hierarchical product parameters in a hierarchy of operational factors for an offering, in accordance with an example implementation of the present subject matter. Although the method 600 may be implemented in a variety of devices, but for the ease of explanation, the description of the method 600 is provided in reference to the above-described system 122. The order in which the method 600 is described is not intended to be construed as a limitation, and any number of the described method blocks may be combined in any order to implement the method 600, or an alternative method.

It may be understood that blocks of the method 600 may be performed in the system 122. The blocks of the method 600 may be executed based on instructions stored in a non-transitory computer-readable medium, as will be readily understood. The non-transitory computer-readable medium may comprise, for example, digital memories, magnetic storage media, such as magnetic disks and magnetic tapes, hard drives, or optically readable digital data storage media.

At block 602, hierarchical product parameters associated with an offering within a hierarchy of operational factors may be obtained. The hierarchical product parameters include at least one lower-tier hierarchical product parameter of the offering. The lower-tier hierarchical product parameters are defined as features or sub-features of the offering. The lower-tier hierarchical product parameters are accompanied by an identifier. This step is important as it forms the foundation for the entire classification process. The hierarchical product parameters represent various aspects of the offering, ranging from high-level capabilities to specific features and sub-features. By obtaining these parameters, the method establishes a comprehensive view of the offering's structure and functionality.

In an example, the hierarchical product parameters may be generated from a product parameter seed. The product parameter seed may be an intermediary memory structure that may be stored, inspected, and retrospected. The product parameter seeds is referred to as clues. The product parameter seeds may be generated by extracting data from a plurality of connected data sources used in an organization and by converting the extracted data into a standard product parameter seed format.

At block 604, an identifier associated with the lower-tier hierarchical product parameter may be retrieved. The identifier may provide information about a hierarchical structure and a location of the lower-tier hierarchical product parameter within the hierarchy of operational factors. The identifier may serve as a key in understanding how different hierarchical product parameters of the offering relate to each other. In an example, the identifier may include unique codes, tags, or labels that may distinguish one hierarchical product parameter from another and indicate its position within the hierarchy of operational factors. This step is essential for maintaining the integrity of the hierarchical structure and ensuring that each hierarchical product parameter is accurately positioned within the overall framework of the offering.

At block 606, an address associated with the identifier may be determined. The address may help in identifying the exact location of each lower-tier hierarchical product parameter within the hierarchy of operational factors. In an example, the address may be a logical designation, a specific reference point, or a unique location within the hierarchical structure. By determining the address, the method creates a clear map indicating where each hierarchical product parameter fits within the larger context of the offering. This step may be particularly important for complex offerings with numerous interconnected hierarchical product parameters, as it helps in maintaining clarity and organization within the hierarchical structure.

At block 608, the lower-tier hierarchical product parameter may be classified under an appropriate hierarchical product parameter based on the determined address. In an example, the appropriate hierarchical product parameter may be either a higher-tier hierarchical product parameter or another lower-tier hierarchical product parameter. Higher-tier hierarchical product parameters are defined as either the offering itself or a capability within the hierarchy of operational factors. The classification step establishes the relationships between different hierarchical product parameters of the offering.

In an example implementation, the information derived from the identifiers and addresses of the lower-tier hierarchical product parameters may be used to infer and construct higher-tier hierarchical product parameters. Further, in scenarios where appropriate user-provided information is available, the user-provided information may be incorporated to refine or override the automatically generated classifications.

By correctly classifying each lower-tier parameter, the method creates a logical and coherent structure that accurately represents the offering's architecture. Further, the classification step is crucial for maintaining the integrity of the hierarchy and ensuring that each hierarchical product parameter is properly contextualized within the larger framework of the offering.

At block 610, a hierarchical link may be established between the classified lower-tier hierarchical product parameter and the appropriate hierarchical product parameter. The hierarchical link may be indicative of a logical relationship between the two parameters. The hierarchical link allows for easy navigation through the various levels of the offering, from higher-tier capabilities down to lower-tier specific features and sub-features.

At bock 612, a hierarchical product parameter map may be updated or modified to reflect the changes associated with the classification. The hierarchical product parameter map serves as a structured representation of the hierarchical product parameters and their relationships within the hierarchy of operational factors for the offering. Keeping the hierarchical product parameter map updated ensures that it accurately reflects the current state of the offering's structure.

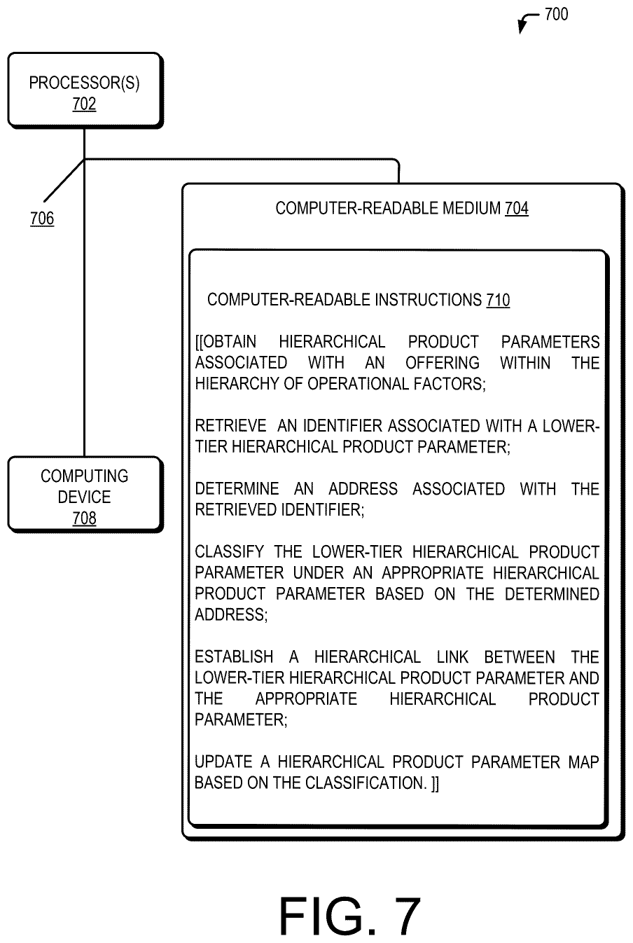

FIG. 7 illustrates a non-transitory computer-readable medium for facilitating classification of hierarchical product parameters in a hierarchy of operational factors for an offering, in accordance with an example of the present subject matter.

In an example, the computing environment 700 comprises processor(s) 702 communicatively coupled to a non-transitory computer-readable medium 704 through communication link 706. In an example, the computing environment 700 may be, for example, the system 122. In an example, the processor(s) 702 may have one or more processing resources for fetching and executing computer-readable instructions 710 from the non-transitory computer-readable medium 704. The processor 702 and the non-transitory computer-readable medium 704 may be implemented, for example, in the system 122.

The non-transitory computer-readable medium 704 may be, for example, an internal memory device or an external memory. In an example, the communication link 706 may be a network communication link, or other communication links, such as a PCI (Peripheral component interconnect) Express, USB-C (Universal Serial Bus Type-C) interfaces, I2C (Inter-Integrated Circuit) interfaces, etc. In an example, the non-transitory computer-readable medium 704 comprises a set of computer-readable instructions 710 which may be accessed by the processor 702 through the communication link 706 and subsequently executed for facilitating optimization of cellular network performance of the network element. The processor(s) 702 and the non-transitory computer-readable medium 704 may also be communicatively coupled to a system 122 over the network.

Referring to FIG. 7, in an example, the non-transitory computer-readable medium 704 comprises computer-readable instructions 710 that cause the processor 702 to obtain hierarchical product parameters associated with an offering within a hierarchy of operational factors. The hierarchical product parameters may include a lower-tier hierarchical product parameter of the offering. The lower-tier hierarchical product parameter refers to a specific element or attribute within a product's hierarchical structure that exists at a lower level of the hierarchy of operational factors. In an example, the lower-tier hierarchical product parameter may be a feature and a sub-feature. In an example, product parameter seeds may be used for obtaining or generating the hierarchical product parameters.

In an example, the computer-readable instructions 710 may then cause the processor 702 to retrieve an identifier associated with the lower tier hierarchical product parameter. The identifier is referred to as an Application Programming Interface (API) path. The identifier may provide information about a hierarchical structure and a location of the lower-tier hierarchical product parameter.

In the example, the instructions 710 may then cause the processor 702 to determine an address associated with the identifier. The address may refer to a unique location or reference point within the hierarchical structure of hierarchical product parameters. The address may be a logical designation that helps in organizing and categorizing different hierarchical product parameters in the hierarchy of operational factors. For example, the address may be a host information. In an example, the address may be a domain of the URL.

Further, the instructions 710 may then cause the processor 702 to classify the lower-tier hierarchical product parameter under an appropriate hierarchical product parameter. The appropriate hierarchical product parameter may be either a higher-tier hierarchical product parameter or another lower-tier hierarchical product parameter. Higher-tier parameters include the offering itself or a capability within the hierarchy of operational factors.

In the example, the instructions 710 may then cause the processor 702 to establish a hierarchical link between the classified lower-tier hierarchical product parameter and the appropriate hierarchical product parameter. The hierarchical link represents the logical relationship between the two parameters. The hierarchical links allow for easy navigation through the various levels of the offering, for example, from high-level capabilities down to specific features and sub-features.

After the classification, the instructions 710 may then cause the processor 702 to update a hierarchical product parameter map to reflect the changes in the hierarchical product parameters. The hierarchical product parameter map serves as a structured representation of all the hierarchical product parameters and their relationships within the hierarchy of operational factors for the offering. In an example, the hierarchical product parameters map may be updated upon detecting any change or relevant information on an existing hierarchical product parameter.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system for classifying hierarchical product parameters in a hierarchy of operational factors for an offering operating in a unified platform, the system comprising:
a processor to:
obtain the hierarchical product parameters associated with the offering within the hierarchy of operational factors, the hierarchical product parameters including at least one lower-tier hierarchical product parameter of the offering, wherein a lower-tier hierarchical product parameter comprises at least one of a feature and a sub-feature, wherein the lower-tier hierarchical product parameter is defined with an identifier;
retrieve the identifier associated with the obtained lower-tier hierarchical product parameter, wherein the identifier is indicative of a hierarchical structure and a location of the lower-tier hierarchical product parameter;
determine an address associated with the retrieved identifier;
classify the lower-tier hierarchical product parameter under an appropriate hierarchical product parameter based on the determined address, the appropriate hierarchical product parameter including at least one of a higher-tier hierarchical product parameter and an other lower-tier hierarchical product parameter, wherein the higher-tier hierarchical product parameter comprises at least one of the offering and a capability in the hierarchy of operational factors;
establish a hierarchical link between the classified lower-tier hierarchical product parameter and the appropriate hierarchical product parameter, wherein the hierarchical link is indicative of a logical relationship between the classified lower-tier hierarchical product parameter and the appropriate hierarchical product parameter; and
update a hierarchical product parameter map based on the classification of the lower-tier hierarchical product parameter, wherein the hierarchical product parameter map is a structured representation of the hierarchical product parameters and their relationships within the hierarchy of operational factors for the offering.

2. The system of claim 1, wherein the unified platform comprises at least one of a developer-end ecosystem and a user-end ecosystem.

3. The system of claim 1, wherein the hierarchy of operational factors is formed of:
the capability as a sub-unit of the offering, wherein the capability represents functions performed by the offering;
the feature as a sub-unit of the capability, wherein the feature represents an item configurable to perform a capability; and
a microservice as a sub-unit of the feature, the microservice representing an executable piece of a programming file for performing the capability; and
a sub-module as a sub-unit of the microservice;
wherein the hierarchical product parameter comprises at least one of the capability, the feature, the microservice, and the sub-module.

4. The system of claim 1, wherein the identifier is an Application Programming Interface (API) path, the API path being defined as Uniform Resource Locators (URLs) and the address being a domain of the URL.

5. The system of claim 1, wherein to determine the address associated with the identifier, the processor is to:
extract the address directly from the identifier when the address is explicitly specified in the retrieved identifier.

6. The system of claim 1, wherein to determine the address associated with the identifier, the processor is to:
obtain at least one of a specification file and a configuration file;
extract an information associated with the address from at least one of the specification file and the configuration file, when the address is not explicitly specified in the retrieved identifier; and
merge the extracted information to identify the address.

7. The system of claim 6, wherein the specification file is a formal document indicative of one or more of a structure, endpoints, parameters, and responses of an API and the configuration file is a routing-rule document indicative of URL patterns and information associated with the address.

8. The system of claim 1, wherein to determine the address associated with the identifier, the processor is to:
extract the information associated with the address from a product parameter seed, wherein the product parameter seed is a structured data object derived from a plurality of connected data sources, each connected data source from amongst the plurality of connected data sources being operated in connection with the unified platform;
extract the information associated with the address from recorded values of the lower-tier hierarchical product parameter stored in a pin table, wherein the pin table is a structured database to record modifications to hierarchical product parameters, and wherein the recorded values include at least one of a user-defined or system-defined modifications of the address; and
identify the address based on the information from the product parameter seed and information from recorded values of the lower-tier hierarchical product parameter.

9. The system of claim 1, wherein the processor is further configured to extract the information associated with the address from the hierarchical product parameter map, wherein the hierarchical product parameter map includes user-provided names for address or a group of address, wherein the group of address includes a common user-provided name.

10. The system of claim 1, wherein the offering operating in the unified platform comprises at least one of a product and a service.

11. A method for classifying hierarchical product parameters in a hierarchy of operational factors for an offering operating in a unified platform, the method comprising:
obtaining the hierarchical product parameters associated with the offering within the hierarchy of operational factors, the hierarchical product parameters including at least one lower-tier hierarchical product parameter of the offering, wherein the lower-tier hierarchical product parameter comprises at least one of a feature and a sub-feature, wherein the lower-tier hierarchical product parameter and is defined with an identifier;
retrieving the identifier associated with the lower-tier hierarchical product parameter, wherein the identifier is indicative of a hierarchical structure and a location of the lower-tier hierarchical product parameter;
determining an address associated with the retrieved identifier;
classifying the lower-tier hierarchical product parameter under an appropriate hierarchical product parameter based on the determined address, the appropriate hierarchical product parameter including at least one of a higher-tier hierarchical product parameter and an other lower-tier hierarchical product parameter, wherein the higher-tier hierarchical product parameter comprises at least one of the offering and a capability in the hierarchy of operational factors;
establishing a hierarchical link between the classified lower-tier hierarchical product parameter and the appropriate hierarchical product parameter, wherein the hierarchical link is indicative of a logical relationship between the classified lower-tier hierarchical product parameter and the appropriate hierarchical product parameter; and
updating a hierarchical product parameter map based on the classification of the lower-tier hierarchical product parameter, wherein the hierarchical product parameter map is a structured representation of the hierarchical product parameters and their relationships within the hierarchy of operational factors for the offering.

12. The method of claim 11, wherein the identifier is an Application Programming Interface (API) path, the API path being defined as Uniform Resource Locator (URLs) and the address being a domain of the URL.

13. The method of claim 11, wherein to determine the address associated with the identifier, the method comprising:
extracting the address directly from the identifier when the address is explicitly specified in the retrieved identifier.

14. The method of claim 11, wherein to determine the address associated with the identifier, the method comprising:
obtaining at least one of a specification file and a configuration file;
extracting an information associated with the address from at least one of the specification file and the configuration file, when the address is not explicitly specified in the retrieved identifier; and
merging the extracted information to identify the address.

15. The method of claim 11, wherein to determine the address associated with each of the identifier, the method comprising:
extracting the information associated with the address from a product parameter seed, wherein the product parameter seed is a structured data object derived from a plurality of connected data sources, each connected data source from amongst the plurality of connected data sources being operated in connection with the unified platform;
extracting the information associated with the address from recorded values of the lower-tier hierarchical product parameter stored in a pin table, wherein the pin table is a structured database to record modifications to hierarchical product parameters, and wherein the recorded values include at least one of a user-defined or system-defined modifications of the address; and
identifying the address based on the information from the product parameter seed and information from recorded values of the lower-tier hierarchical product parameter.

16. The method of claim 11, the method comprising:
extracting the information associated with the address from the hierarchical product parameter map, wherein the hierarchical product parameter map includes user-provided names for address or a group of address, wherein the group of address includes a common user-provided name.

17. A non-transitory computer-accessible storage medium storing program comprising instructions for classification of hierarchical product parameters in a hierarchy of operational factors for an offering operating in a unified platform, the instructions being executable by a processor to:
obtain the hierarchical product parameters associated with the offering within the hierarchy of operational factors, the hierarchical product parameters including at least one lower-tier hierarchical product parameter of the offering, wherein a lower-tier hierarchical product parameter comprises at least one of a feature and a sub-feature and is defined with an identifier;
retrieve the identifier associated with the lower-tier hierarchical product parameter, wherein the identifier is indicative of a hierarchical structure and a location of the lower-tier hierarchical product parameter;
determine an address associated with the retrieved identifier;
classify the lower-tier hierarchical product parameter under an appropriate hierarchical product parameter based on the determined address, the appropriate hierarchical product parameter including at least one of a higher-tier hierarchical product parameter and an other lower-tier hierarchical product parameter, wherein the higher-tier hierarchical product parameter comprises at least one of the offering and a capability in the hierarchy of operational factors;
establish a hierarchical link between the classified lower-tier hierarchical product parameter and the appropriate hierarchical product parameter, wherein the hierarchical link is indicative of a logical relationship between the classified lower-tier hierarchical product parameter and the appropriate hierarchical product parameter; and
update a hierarchical product parameter map based on the classification of the lower-tier hierarchical product parameter, wherein the hierarchical product parameter map is a structured representation of the hierarchical product parameters and their relationships within the hierarchy of operational factors for the offering.

18. The non-transitory computer-accessible storage medium of claim 17, wherein to determine the address associated with the identifier, the instructions cause the processor to:
extract the address directly from the identifier when the address is explicitly specified in the retrieved identifier.

19. The non-transitory computer-accessible storage medium of claim 17, wherein to determine the address associated with the identifier, the instructions cause the processor to:
obtain at least one of a specification file and a configuration file;
extract an information associated with the address from at least one of the specification file and the configuration file, when the address is not explicitly specified in the retrieved identifier; and
merge the extracted information to identify the address.

20. The non-transitory computer-accessible storage medium of claim 17, wherein to determine the address associated with the identifier, the instructions cause the processor to:
extract the information associated with the address from a product parameter seed, wherein the product parameter seed is a structured data object derived from a plurality of connected data sources, each connected data source from amongst the plurality of connected data sources being operated in connection with the unified platform;
extract the information associated with the address from recorded values of the lower-tier hierarchical product parameter stored in a pin table, wherein the pin table is a structured database to record modifications to hierarchical product parameters, and wherein the recorded values include at least one of a user-defined or system-defined modifications of the address; and
identify the address based on the information from the product parameter seed and information from recorded values of the lower-tier hierarchical product parameter.
